(19) United States
(12) Patent Application Publication
(10) Pub. No.: US 2023/0371739 A1
(43) Pub. Date: Nov. 23, 2023

(54) ASSISTED COOKING

(71) Applicant: ELECTROLUX HOME PRODUCTS INC., Charlotte, NC (US)

(72) Inventors: John W. TAYLOR, Charlotte, NC (US); Sabari GOPALAKRISHNAN, Springfield, TN (US)

(21) Appl. No.: 18/028,186

(22) PCT Filed: Dec. 18, 2020
(86) PCT No.: PCT/US2020/065866

§ 371 Date: Mar. 23, 2023

Related U.S. Application Data
(60) Provisional application No. 63/087,975, filed on Oct. 6, 2020.

(51) Int. Cl. A47J 36/32; H05B 3/74; A23L 5/10

(52) U.S. Cl. CPC A47J 36/321; H05B 3/74; A23L 5/10; H05B 2213/07; G01F 23/292

(57) ABSTRACT

A cooking assistant unit is disclosed, the cooking assisting unit having an arrangement including a temperature sensor for detecting heat emanating from the cooktop surface, a time of flight sensor for detecting a level of liquid in a utensil cooking on a heating element of the cooktop and a display for displaying a visual message directly on foodstuff accommodated within the utensil, on the cooktop surface or elsewhere. A determination of where is the current foodstuff preparation with respect to a recipe and the visual message may be made to include instructions on a next step in the recipe as well as countdown to the performance of the next step.

### BACKGROUND OF THE INVENTION

The present disclosure relates to a cooking assistant unit and more particularly to a system and method for assisting and supporting efficient and effective cooking on a cooktop along with improving skillsets and experiences arising from the cooking. There is a continual need to improve conventional use of cooktops, such improvements arising from enhancing and easing control of cooktops and foodstuffs cooking in utensils thereon as well as assistance with execution of the steps of meal preparation recipes. The need further extends to a robust application across different cooking appliances and heat generation methods, such methods including but not limited to induction, radiance and gas.

Cooktops find use in both professional and private settings and as used herein shall refer to any cooking appliance for cooking foodstuff, including but not limited to cooktops, free-standing ranges with cooktop surfaces, hoods, microwaves and the like as envisioned by the skilled person. It is not uncommon for the professional chef to multitask among a plurality of dishes in various states of simultaneous preparation and cooking on a cooktop surface. A direct consequence is a chef's divided attention which in turn may lead to delayed or forgotten performance of a next recipe step. As a result, the prepared dishes may suffer in quality while kitchen operations and moral may suffer. Accordingly, the professional chef would benefit from assistance with a state of foodstuff preparation, enhanced control of the heat generation in the cooktops and reminders of current and next recipe steps. The same may apply, albeit to different degrees, to the home chef. Further, many chefs may not be in possession of certain useful equipment such as temperature sensors for determining the temperature of a foodstuff under preparation, sufficient understanding of more complex cooktops to enable adequate use thereof, sufficient understanding of eminent hazardous situations along with their prevention and/or suppression, and so forth. Likewise, many current such temperature sensors comprise invasive probes requiring direct contact with the foodstuff, the direct contact possibly interfering with the preparation and/or damaging of the foodstuff, utensil cooktop and the like.

Accordingly, there is a need to assist and support a chef operating a cooktop surface with appropriate and useful information on a current status of specific foodstuff cooking on a cooktop surface, current and/or next applicable recipe along with progress therewith as applied to specific foodstuff cooking and the like.

A number of solutions have been proposed in the art to affect the aforementioned. For example, Bach, in U.S. Pat. No. 9,109,805, proposes a range hood 115 including a number of temperature sensors 120, arranged in the range hood and positioned in either a one to one relationship with heating elements 105 on a cooktop surface 110 (see FIG. 1) or one to all single sensor 140 relationship for an entirety of the cooktop surface (see FIG. 2). The temperature sensor may be used to detect the temperature of a heating element and/or of the cooktop surface in its entirety and/or that which is cooking on the heating element. Illumination warning devices 125 may be arranged to illuminate warning messages on particular hazardous hot heating elements (see FIG. 3) or generally on and for the surface itself (see FIG. 4). Bach further proposes extending his warning system to heating elements that may be operating for an extended period of time as well as for heat detected above certain thresholds known to be associated with dangerous cooking conditions, such as the known temperature threshold for when standard cooking oil may become flammable. Determined hazardous or dangerous situations may lead to automatic remedial efforts including hood fan engagement and safety shut offs. As such, Bach is focused on dangerous situation detections and providing warnings along with remedial actions therefor rather than assistance and support with meal preparation and control of foodstuff cooking in support thereof.

Kamei, in U.S. patent application Ser. No. 15/477,192, is directed to a cooking support system 100 that monitors cooking surface temperatures with the aid of: control device 110, processing unit 190, light emitter 191, camera 192 and overhead infrared sensor 193; all of which are positioned overhead from the cooktop 300. In operation, Kamei uses camera 192 to capture an image of a cooking surface including any cookware 400 that may be positioned thereon. The IR sensor is then used to detect a temperature of each cooking surface including any cookware atop the cooking surface. The temperature and location of temperature are fed to the processing unit which, in turn, is then used to recognized when portions of the cookware may be overheating. Upon detection of a dangerous condition, a warning to the cooktop operator is triggered via the light emitter emitting a particular warning light onto the cooktop. Here, Kamei particularly measures portions of cookware edges and compares such measured temperatures with predetermined thresholds, the exceeding of which becomes indicative of the warning situation. Kamei, like Bach, focuses on dangerous situation detections and providing warnings and remedial actions therefor rather than assistance and support with meal preparation and control of foodstuff cooking therefor.

Johnson, in U.S. patent application Ser. No. 14/924,900, is directed to a cooktop appliance 12 including a cooking surface 14 with heating elements 16 arranged to heat up cooking utensils 18. A cookware temperature sensor 28 and food sensor 30 associated with the cookware are further included whereby the food sensor is a probe which is physically positioned within the utensil 18 to physically engage foodstuff therein. Accordingly, the sensor determines the temperature of the food. As with the aforementioned references, Johnson focuses on dangerous situations which, as may be the case here, may result in burnt food. Accordingly, measurements of both the different temperatures of the food and the utensil are taken and compared with a threshold. Exceeding the threshold is understood to be a warning situation necessitating remedial measures such as reducing the heat being generated under the particular food and utensil. Unlike Bach and Kamei, temperature sensing in Johnson is not performed overhead and in a contactless manner. Like Back and Kamei, Johnson is not directed to assistance and support with meal preparation and control of foodstuff cooking therefor.

### BRIEF SUMMARY OF THE INVENTION

Accordingly, embodiments of the present disclosure are provided to substantially obviate one or more of the problems arising out of the limitations and disadvantages of the related art in providing robust solutions including providing a cooking assisting unit having, as may be dependent upon embodiment, a temperature sensor for detecting temperature at a distance, a time of flight detector for detecting the presence or absence of a utensil and a level of liquid in a present utensil, a digital light processor for generating and displaying a visible image of real time cooking information at and on the cooktop surface and foodstuff in particular, and a communication module, integrated into a sensor or as a standalone, configured to determine certain real time cooking information to be included in the displayed message as well as download recipes and determine current and subsequent recipe steps based upon current detected conditions.

The real time cooking information may include: the current foodstuff or utensil temperature, countdown to and identification of a next recipe step, warning or alarm about a dangerous or eminently dangerous situations, a presence and absence of the utensil and other information as detailed hereinbelow.

The communication module may further be in communication with the cooktop and external information sources, the former for communicating desired and actual temperatures of heat applied to a particular foodstuff under preparation and the latter for communicating recipes and various steps thereof in particular. The communication may be wired or wireless.

The cooking assisting unit may be mounted in a vent hood or in a swing arm. The temperature sensor may comprise one or more IR sensors, the time of flight sensor may comprise one or more sensors operating in the infrared and the digital light processor may be laser based. The sensors may also comprise sensor arrays. The cooking assisting unit may be applied across different cooking appliances and heat generation methods, such methods including but not limited to induction, radiance and gas. Such cooking appliances may include cooktops, free standing ranges with cooktops on top, hood, microwave ovens and the like.

### BRIEF DESCRIPTION OF THE SEVERAL VIEWS OF THE DRAWINGS

The accompanying drawings, which are incorporated in and constitute a part of this disclosure, illustrate exemplary embodiments and, together with the description, serve to explain the disclosed principals.

FIGS. 1A and 1B depict an application of the cooking assisting unit.

FIG. 1C depicts an example operation of a temperature sensor.

FIG. 1D depicts an application of a temperature sensor across a cooktop surface.

FIG. 1E depicts an application of a temperature sensor on a cooktop heating element.

FIG. 1F depicts components of a temperature sensor in a current application.

FIG. 1G depicts an exploded and operational of a digital light processor.

FIG. 1H depicts application of a time of a flight sensor to liquid level detection and utensil presence determination.

FIG. 2A depicts a cooking assisting unit mounted in a vent hood.

FIG. 2B depicts a cooking assisting unit mounted in a swing arm.

FIG. 3A depicts an exploded view of the cooking assisting unit.

FIG. 3B depicts an assembled view of the cooking assisting unit of FIG. 3A.

FIG. 4A depicts an application of the cooking assisting unit, namely, example displaying real time cooking information on foodstuff.

FIG. 4B depicts an application of the cooking assisting unit, namely, example displaying real time cooking information and introducing foodstuff into a utensil.

FIGS. 5A-5B depicts an application of the cooking assisting unit, namely, example displaying an image within a utensil.

FIGS. 6A-6B depict methods for providing cooking assistance according to embodiments of the present disclosure.

### DETAILED DESCRIPTION OF THE INVENTION

The technology described herein finds application in assisting and supporting food preparation on a cooktop surface comprising one or more heating sources. Typically, a utensil used in the food preparation is brought proximate to the heat source so that heat is transferred from source to utensil. Foodstuff, any substance that is used as food or to make a meal, may be accommodated with or in the utensil with the transferred heat facilitating operation on the foodstuff, namely, foodstuff placed in a utensil on a heating source is cooked for a particular amount of time and temperature such that the foodstuff attains certain states as may be according to meal preparation recipes and the like.

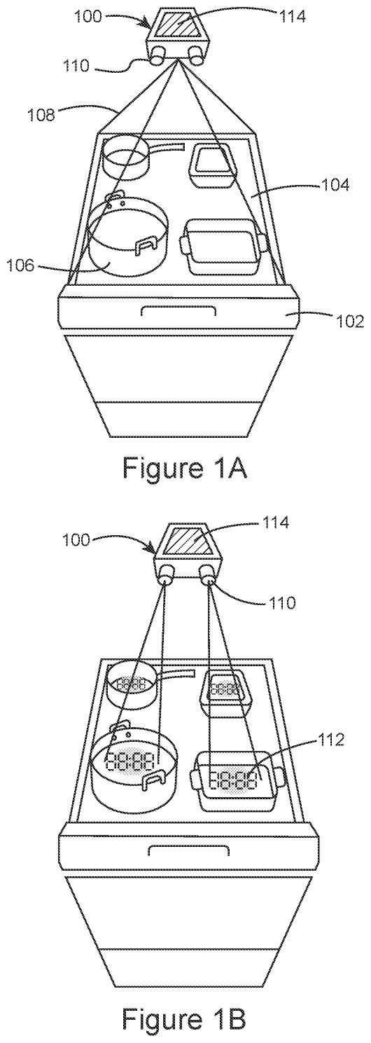

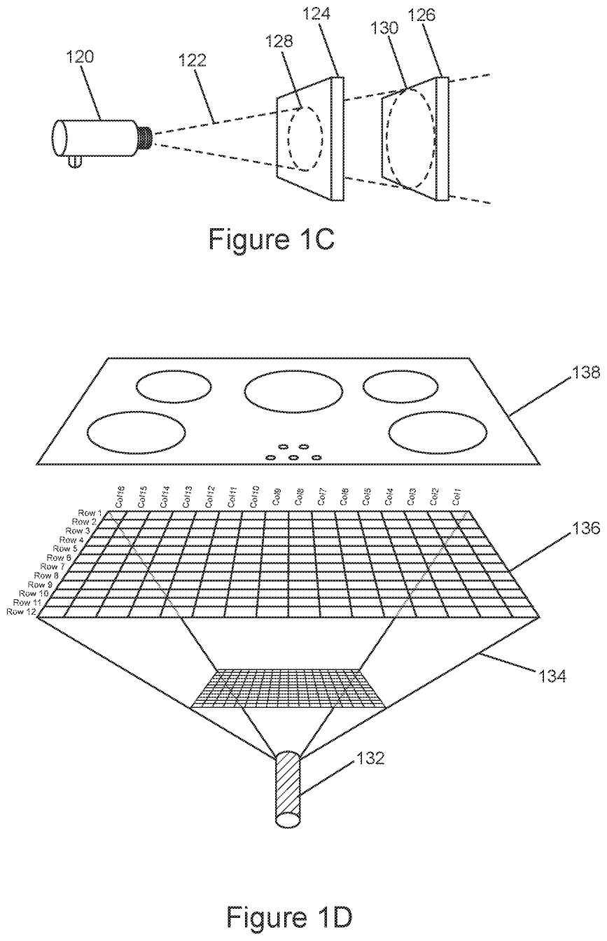

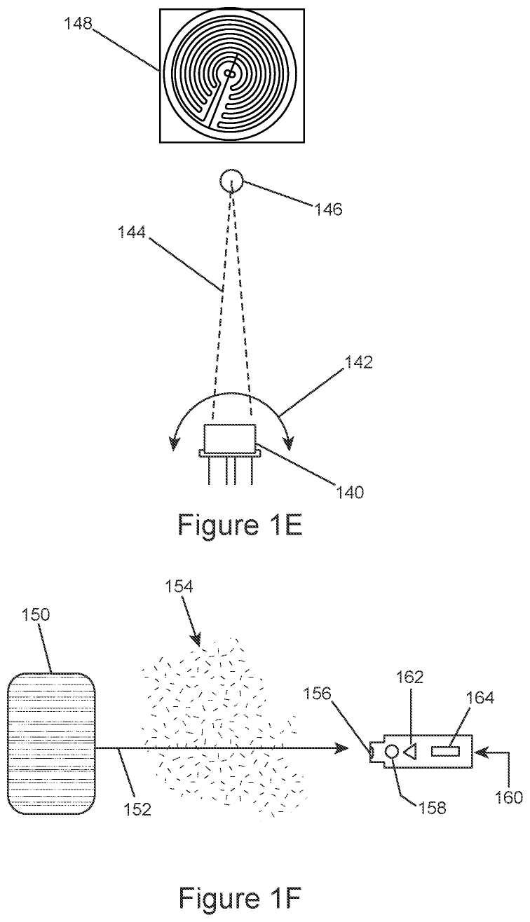

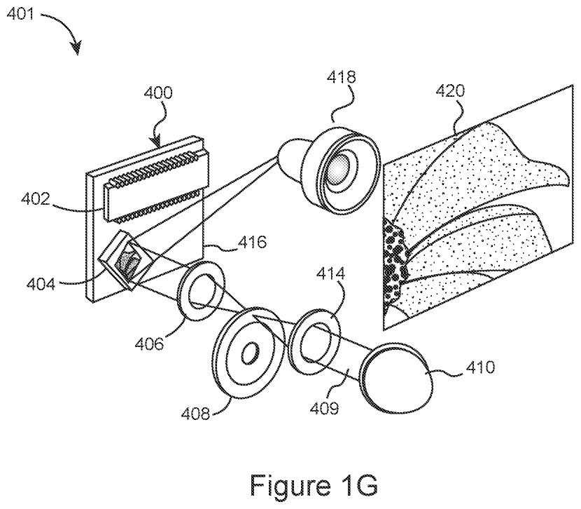

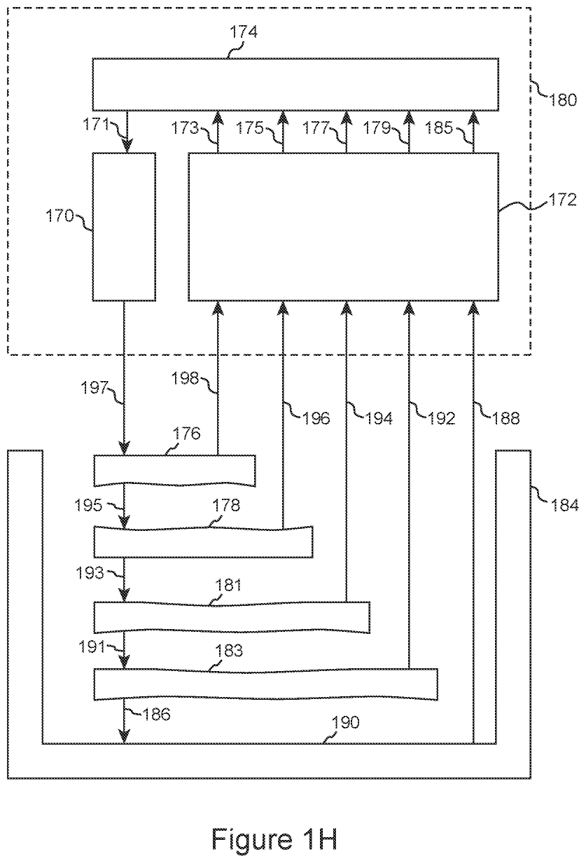

Effective operation of the cooktop, foodstuff preparation and any underlying recipes steps (current and next) are essential for the preparation of a good meal. Accordingly, advantageous features of the present embodiments include effective and timely imparting of required and useful information to the chef regarding the aforementioned and other conditions of importance to effective cooking. Such knowledge should be readily, quickly and easily available to and understood by the chef. Embodiments of the present disclosure are thus directed to appropriate displays in select locations of relevant information, first examples of which are depicted in FIGS. 1A and 1B.

FIG. 1A depicts an environment in which a first embodiment of the cooking assisting unit 100 may operate. As shown, the cooking assisting unit 100 is arranged above a cooktop 102 having a cooktop surface 104 with a number of heating elements (not shown) upon which a number of utensils 106 rest.

The cooking assisting unit 100 comprises at least one temperature sensor and at least one digital light processor (DLP) assembly 110. The temperature sensor may be a remote and contactless temperature sensor operating in the infrared and the DLP may operate by laser. At least one processor is included in the cooking assisting unit 100, the processor being optionally arranged on a single board computer. Examples of known single board computers include the Beagleboard series available from Texas Instruments and Raspberry PI series available from the Raspberry PI Foundation. The processor is arranged in communication with the cooktop controls such that heat generation information, such as temperature settings inputted into the cooktop, are communicated with the processor for subsequent consideration including comparison with an actual temperature of a foodstuff under preparation by the cooktop inputted temperature setting. The comparison may then further be used in a feedback loop to adjust the temperature input setting of the cooktop by the processor such that the foodstuff temperature reaches a desired level. The temperature sensor is arranged in electrical communication with the processor via the board upon which the processor is mounted such that output from the temperature sensor may be received and processed at and by the processor and the board in turn may power the temperature sensor. Such an arrangement may be made by appropriate connection of temperature sensor pins with board's input/output (I/O). The DLP is also arranged in electrical communication with the processor such that an image generated by the processor may then be selectively displayed at a select location outside the cooking assisting unit 100 by the DLP. The select location may include the cooktop surface, utensil, foodstuff, nearby wall or surface and the like. The DLP may comprise a plurality of pins arranged in a matrix that line up with expansion headers of single board computers facilitating a plug-in arrangement. Other connection arrangements between and among the aforementioned may be made as envisioned by the skilled person.

In another embodiment, the cooking assisting unit 100 further comprises at least one time of flight (ToF) sensor arranged in electrical communication with the processor in a similar manner as per the aforementioned. Output from the ToF sensor may be received and processed by the processor in the generation of the aforementioned image. The ToF sensor is arranged above the cooktop surface such that a location for a utensil falls within a line of sight of the ToF sensor and the ToF sensor may then in turn generate an output based upon a detected reflection, the output being subsequently processed to determine whether the utensil is present and a level of any liquid accommodated within the present utensil. Such output may be obtained over time such that, for example, a rate of change of liquid within the utensil can be determined. Example application of the aforementioned include monitoring an increase in fluid levels due to boiling, the increase potentially leading to an undesired boil over. Additionally, fluid level reduction as may occur from sauce reduction may also be monitored, the decrease potentially leading to an undesired evaporation/disappearance or destruction of the sauce. Other distances may also be determined, such as a distance between utensil or liquid and cooking assisting unit.

The sensors and/or DLP may comprise individual standalone components mounted on individual circuit boards or may be arranged in combination on a single circuit board. Cooktop 102 is depicted as a typical household appliance though may comprise any suitable apparatus for generating heat applicable for cooking foodstuff which includes communication capabilities with the aforementioned processor. Such may include free standing range with cooktop on top, hood, microwave and the like. Heat generation may include resistance, induction, radiance, gas and the like as would be applied by the skilled person. The utensils 106 are depicted as common variety pots and pans for illustrative purposes.

In still another embodiment, the cooking assisting unit 100 may include a communication module arranged in electrical connection with the processor and configured to download meal preparation recipes (and steps thereof) to the processor which may then compare current detected meal preparation steps of a particular recipe with the actual recipe steps themselves thereby leading to a determination of a current and next step, the information therefrom then also being selectively introduced into the image. The information may include images of foodstuff in various stages of preparation along with alphanumeric characters, colors and the like. The process may be arranged, configured and programmed to affect the aforementioned as envisioned by the skilled person.

Returning to FIG. 1A, utensils 106 are positioned within a line of sight 108 of cooking assisting unit 100. Temperature sensor and projector assembly 114 is arranged to enable temperature sensing of all or part of the cooktop surface 104 as well as display a select image thereon or within a utensil. The select image displayed by the DLP comprises real time cooking information 112, such as alphanumeric characters, images and/or colors, directly on the cooktop surface or, as depicted in FIG. 1B, within a utensil. By way of example, the real time cooking information displayed in FIG. 1B includes foodstuff temperature information obtained and determined in a manner set out above. As further depicted in FIG. 1B, the cooking assisting unit 100 may further include a fixing element for mounting the unit, the fixing element comprising, for example, magnetic elements, Velcro, an adhesive layer 114 and other such fixing elements as envisioned by the skilled person.

With respect to infrared (IR) sensors, the area to be measured (i.e., the target) should at least fill the instrument's field of view and ideally largely overlap. For example, as depicted in FIG. 1C, temperature sensor 120 has a field of view 122 on a proximate target 124 and distal target 126; the targets being intended for temperature measurement. Accordingly, first and second measurement spots 128 and 130 are created on the proximate and distal objects 124 and 126 respectively. The second spot 130 being about equal to the target size represents a good arrangement for assessing an overall temperature of target 126; while first spot 128, being smaller than target 124, represents a good arrangement for assessing a temperature in and at a more specific location, namely, a center and lightened portion of target 124. In addition to optical geometry as depicted in FIG. 1C, geometrical optics may be used to adjust (widen or focus) a measurement spot size and location as well as the field of view generally. Temperature sensors may also be pivotably mounted to physically adjust location of the field of view, measurement spot and the like.

FIG. 1D depicts the temperature sensor configured for a wider field of view, namely, covering most if not all of the surface of a cooktop. As depicted, sensor 132 includes a field of view 134 which may be considered as a grid 136 the size of which proximately matches at least a desired portion of cooktop surface 138. As shown, sensor 132 includes a reference tab RT and four pins, clock line SCL, ground GND, supply voltage VDD and serial data signal SDA, all configured and arranged to enable electrical connection and communication with the aforementioned processor via an I/O. In operation, by virtue of the depicted field of view, sensor 132 may determine temperature distributions on the cooktop surface 138 with the same finding representation in grid 136.

With reference to FIG. 1E, the temperature sensor 140 may then be selectively pivoted 142 in order to direct its field of view 144 and measurement spot 146 in particular on a desired location on the cooktop surface, such as heating element 148.

Operation of a temperature sensor in a kitchen environment is depicted in FIG. 1F. As shown, cooktop surface 150 emits thermal radiation 152 to be collected and measured by temperature sensor 160 in a smoky and/or humid environment 154. Facilitating thermal radiation collection, the sensor 160 includes optics 156 arranged to focus incident radiation and correct for any potential environmental obstructions onto photosensitive detectors 158 which then convert the incoming thermal radiation into electrical signals via amplification 162 and electronics 164. Other temperature sensor arrangements, including for example use of thermopiles, may be applied here by way of design choice. The electrical signals may then be converted into temperature values and further processed with respect to, for example, recipe steps, by the aforementioned processor or by other remote processing functionality. Accordingly, the instant temperature sensor operates in a contactless and remote manner so as not to obstruct or interfere with the cooktop environment nor potentially impact or damage foodstuff, utensils and the like operating or present in such environments.

A functional depiction of a DLP is set out in FIG. 1G, wherein, the digital light processing element 401 comprises a DLP Chip Board 400 on which processor 402, digital micromirror device (DMD) 404 and memory 416 are suitably mounted and configured. Incident radiation 409 from source 410 is color filtered 408 and focused, via for example a shape lens 406, onto DMD 404 from which an image 420 may be generated and projected 418 onto a screen 412. As applied to the embodiments set out herein, the projected image may comprise select images, alphanumeric text and/or color and/or the like which is then selectively projected onto a screen of the cooktop surface, utensil and/or food and the like.

In an embodiment and with general reference to FIG. 1H, the cooking assisting unit 100 includes at least one time of flight (ToF) sensor configured for detecting a level and change of level of liquid contained in a utensil which is located in the ToF sensors' field of view, as well as confirming the physical presence or absence of the utensil itself. As depicted, ToF sensor 180 includes transmitter 170 arranged to transmit a signal of known speed at and into utensil 184. The signal may comprise infrared light. The light is reflected from the utensil, the detection of which confirms the utensil's presence. The light may further reflect off of the surface of liquid present in the utensil. As depicted, starting with where no liquid is present in the utensil, light incidence 186 is reflected 188 off the internal bottom 190 of the utensil. A lowest liquid level 183 produces a first reflection 192 based upon a first incidence 191. Should the liquid rise, for example to a next higher level 181, as may be the case with boiling, a second reflection 194 is produced from a second incidence 193. Likewise, third and fourth reflections (196, 198) may be produced by third and fourth incidences (195, 197) at next higher levels (178, 176). Similarly, where liquid initially starts from a higher level and evaporates, as may be the case from reducing, the aforementioned would run in the inverse.

Functionally, the ToF sensor may operate to statically determine a single liquid level in a single point in time; or non-statically determine a change in level height over a period of time. The distance to the liquid level at a particular time may be determined by analyzing the time difference between the time of emission, signal 171, and time of receipt of a particular reflection or return signal (173, 175, 177, 179, 188) to the sensor 180 after being reflected by the respective surface level of liquid (176, 178, 181, 183, 190). A number of different analysis may be applied for this calculation without departing from the spirit of the present embodiments. One such calculation entails multiplying the speed of the infrared light times the time of flight (to and from the liquid surface) and then divide the product by 2. Timer 174 may be employed to start during the exit of the infrared light and run until the respective return reflection is detected. The aforementioned processor may be appropriately configured and programmed to affect the aforementioned.

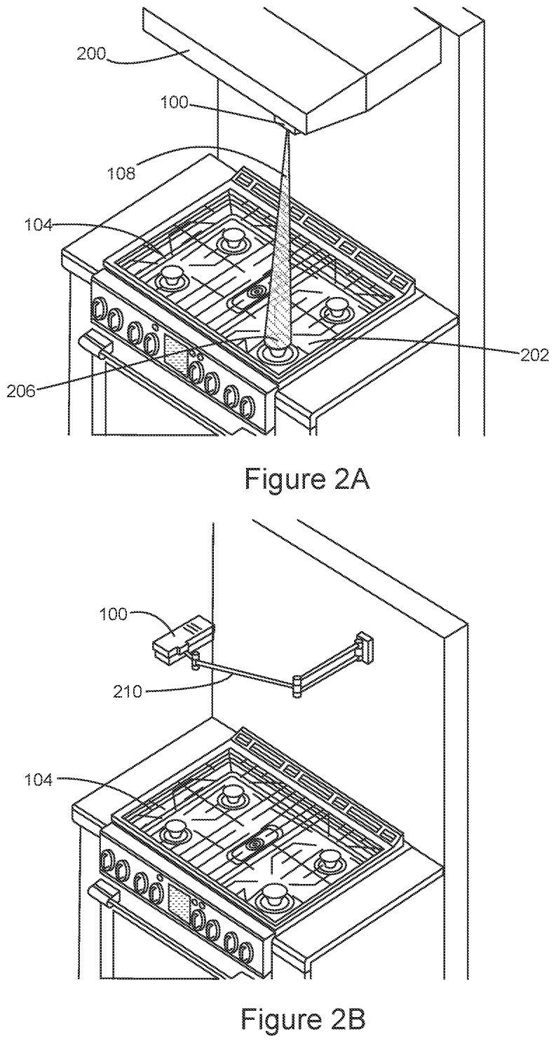

As depicted in FIG. 2A, the cooking assisting unit 100 may be mounted in a vent hood 200 above and overlooking a cooktop surface 104. In this example arrangement, the sensor field of view 108 is adjusted so as to train on heating element 202 so as to create a measurement spot 206 on a particular part of the heating element 202.

As depicted in FIG. 2B, the cooking assisting unit 100 may be mounted on a swing arm 210 so as to be selectively arranged above cooktop surface 104. Alternatively, the cooking assisting unit may be mounted under a floor of or elsewhere within or on a microwave oven (not shown).

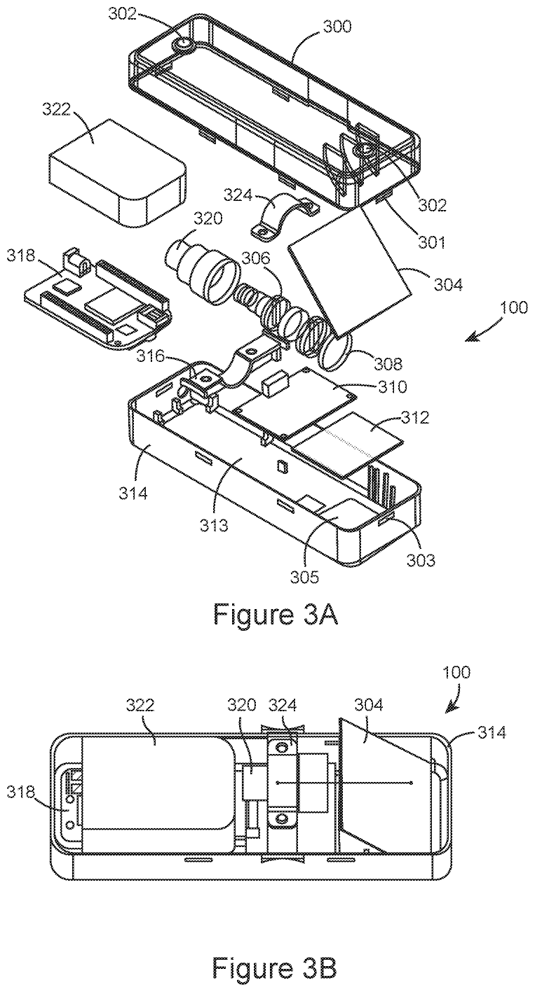

FIG. 3A depicts an exploded view and FIG. 3B depicted an assembled view of the cooking assisting unit 100 according to various embodiments of the present disclosure. With general reference to both figures, arrangement 100 includes a top housing 300 configured to mate with a base housing 314 by way of example clamps and clamp openings (301, 303) which may be arranged in a fixing relationship to mechanically fix the top housing 300 and base housing 314 together. Magnets 302 may be arranged on top of the top housing 300 for magnetically mounting the cooking assisting unit 100 as for example depicted in FIGS. 2A and 2B, while other mounting elements may be used with or in place of the magnets.

The order of the elements accommodated within cooking assisting unit 100 are set out in an illustrative order. Board 318 may comprise the aforementioned single board computer arranged and configured to facilitate electrical communication with other elements housed within the cooking assisting unit 100 as well as with external devices by virtue of wireless communication. A sensor board 310 is further arranged to be in electrical communication with board 318 facilitating, together with board 310, accommodation and operation of the aforementioned sensors, including the temperature sensor and time of flight sensor (not shown). As such, the sensors may be individually mounted on separate boards or collectively arranged on a single board.

Returning to FIG. 3A, in the depicted cooking assisting unit 100, board 318 is arranged on a bottom 313 and within the confines of base housing 314, proximate to sensor board 310 and clear cover 312 which overlays opening 305 in the base housing. Optics holder 316 is arranged over sensor board 310, the optics holder 316 including accommodations for a lens holder 320 thereon. Within lens holder 320 are a number of optical elements including an optical lens and a lock ring locking the optical elements within the lens holder. Clamp 324 configured to overlay the lens holder 320 and mate with the optics holder 316 is arranged to hold the lens holder 320 in place while fixed to the optics holder 316. A mirror 304 is arranged proximate to the clear cover 312 at an angle, such as 45 degrees, such that radiation impinging thereon is reflected from the lens arrangement through the clear cover and out the opening 305 in the direction of the cooktop surface (not shown). A DLP, such as digital light processor display evaluation module 322 is arranged herein and configured to selectively project and display the image including real time cooking information below the cooking assisting unit with the processor, being in electrical communication with the DLP, generating the image and controlling the display location. The DLP may be of the compact, plug and play variety suitable for mobile projectors, appliances and the like. Its features may include an own chipset, such as the DLP200 (nHD), optical engine which may support up to 30 lumens, and an 8/16/24-bit RGB parallel video processor interface. The DLP may be board ready via, for example, an underside which includes pins arranged and configured to plug into an aforementioned single board computer and the like. The DLP may be further configured by the skilled person to generate free-form and on-demand displays.

Other features may be included and/or substituted as would be understood by the skilled person. Forms and adhesive gaskets typically used for accommodating components in a housing are not shown for clarity purposes but would nonetheless be understood by the skilled person to be included and arranged within the cooking assisting unit 100.

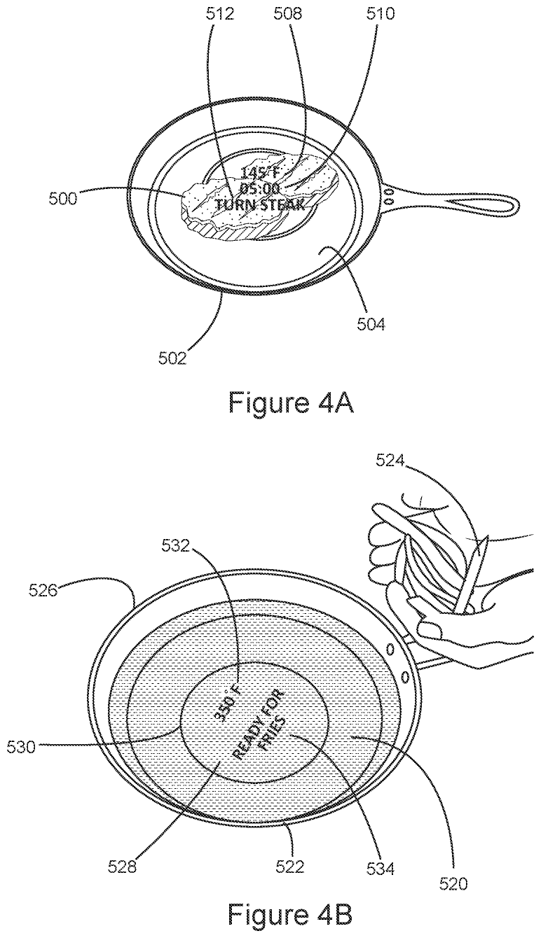

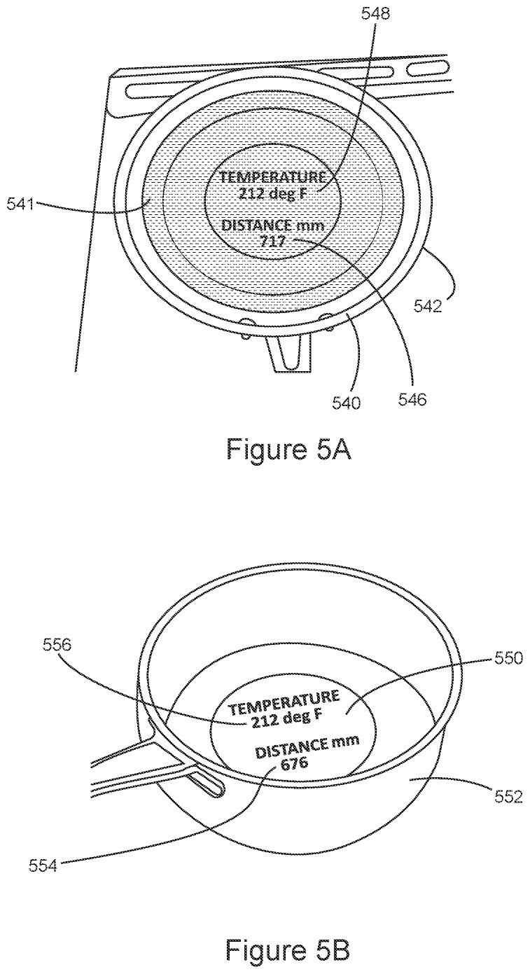

In operation, the cooking assisting unit projects and displays images comprising the real time cooking information on at least one of the cooktop surface, utensil and foodstuff. The real time cooking information including but not limited to the following alone or in combination: foodstuff temperature, a cooking time, a meal recipe step, cooktop surface temperature, liquid level indicia, alarms, images of foodstuff in various stages of preparation, colors, alpha-numeric characters, other images and the like. The foodstuff may be located in the utensil or elsewhere on the cooktop surface as may be required by its current recipe and/or the imagination of the chef. FIGS. 4A-5B depict different images including real time cooking information therein.

By way of example and starting with FIG. 4A, a steak 500 is frying in a frying pan 502 on a heating element (not shown) operating on a heating location of a cooktop surface 504. A recipe for steak preparation has been locally stored and/or available to the aforementioned processor at the cooking assisting unit. A determination of a current step in the preparation process defined by the recipe is determined by the aforementioned processor making use of at least output from the temperature sensor and time duration since start. Accordingly, a countdown to the next recipe step may be determined and identified. A current temperature of the steak is further taken, and the image so generated to comprise real time cooking information comprising current steak temperature (45 degrees Fahrenheit, 508), countdown (5 minutes, 510) and next recipe step (turn steak, 512).

In FIG. 4B, oil 520 is depicted heating up in a frying pan 522 in preparation for the introduction of French fries 524 for frying based upon a recipe locally stored and/or otherwise available to the aforementioned processor. Frying pan 522 is arranged onto of a cooktop surface 526 and heating element (not shown) thereof. A heat and level of the oil is determined and when the heat and oil level correspond to a next step in the recipe for French fries' preparation, the real time information 528 is generated and displayed. The displayed real time information 530 includes temperature of the oil (350 degrees Fahrenheit) 532 and a message 534 that the oil is ready for introduction of the French fries thereinto.

FIGS. 5A and 5B depict real time cooking information displayed within a utensil. Starting with FIG. 5A, utensil 540 is positioned on cooktop surface 542 in the line of sight of the ToF sensor (not shown), the utensil including a certain amount of liquid (541) therein. By virtue of the aforementioned operation, the ToF sensor and processor determine the distance of the liquid to the ToF sensor. Where the height of the utensil 540 is known in advance of this, a simple calculation may be applied to determine the level of the liquid with respect to the utensil. The temperature of the liquid is taken with the temperature sensor and real time cooking information being displayed on the oil; the displayed information including the liquid temperature (548) and distance of liquid to a select point (546) may then be made within the utensil. Likewise, as depicted in FIG. 5B, real time information may be displayed (550) within utensil 552, the displayed information comprising an indication of temperature (556) and a certain distance (554).

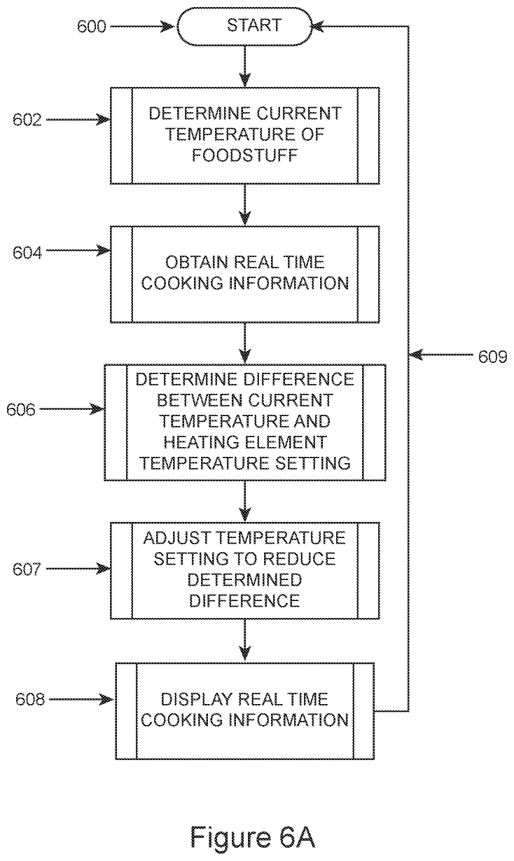

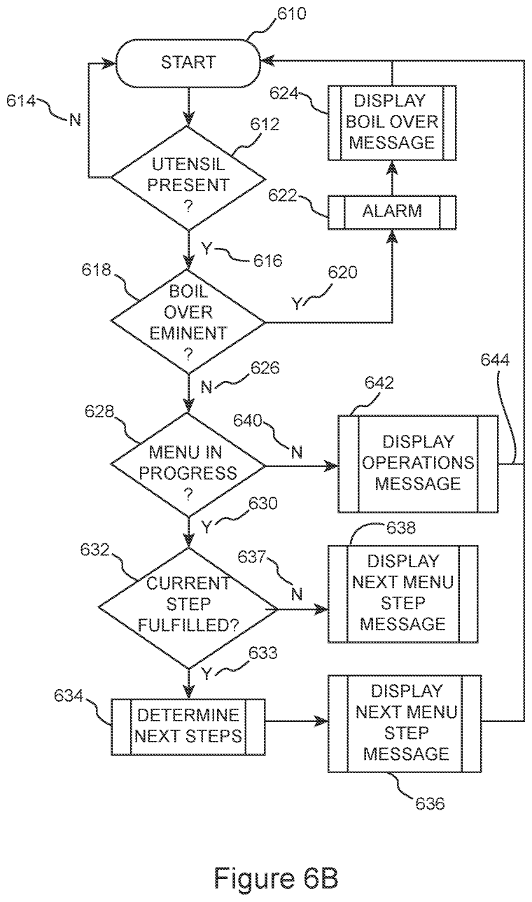

A method for supporting foodstuff preparation is set out in FIGS. 6A and 6B. Starting with FIG. 6A, the depicted method begins at step 600 and continues with a determination of a current temperature of foodstuff (602) cooking on a cooktop surface within the field of view of the temperature sensor. Next, real time cooking information is determined (604). The real time cooking information may include a temperature setting for a heating element of the cooktop which is used to impart heat onto the foodstuff and/or utensil. Next, a difference between the foodstuff temperature and temperature setting of the heating element is determined (606) followed by instructions to the cooktop to adjust the heating element setting so as to reduce the difference (607). The real time cooking information is then displayed (608) on at least one of the foodstuff, cooktop surface, utensil and nearby wall or surface. The real time cooking information may selectively comprise at least one of foodstuff temperature, heating element temperature setting, duration of cooking and the like as set out herein. The method may then repeat by way of feedback loop (609) such that the temperature setting of the heating element and/or display are regularly updated. The instructions may alternatively be communicated to the chef for manual adjustment of the cooktop heating element.

A further method embodiment is depicted FIG. 6B. Here the method begins 610 and continues with a determination of whether a utensil is present (612). Where a utensil is determined not to be present (614), the method loops back to start (610). Where a utensil is determined to be present (616), a next determination (618) is made as to whether a boil over situation is present or eminent. As detailed in the aforementioned, boil over situations occur when a level of liquid in a utensil rises above the containing limit of the utensil due, for example, to overheating the liquid. Where it is determined that a boil over situation exists or is about to occur (620), an alarm (622) and real time cooking information by way of a boil over message is displayed (624). The method then loops back to start (610) so that the method may begin again. Where a boil over situation is determined not to be present or eminent (626), a next query is made whether a dish recipe is in progress (628) and if so (630) whether a current step in the recipe has been fulfilled (632). If fulfilled (633), a determination of the next sequential menu step is made (634) and displayed for the chef (636). If the step is unfulfilled (637) the current menu step is displayed (638). If no menu is in progress (640), an operations message may be displayed (642) and then the method reverts back to start.

The communication functionality of the present embodiments may comprise network and communication chips, namely, semiconductor integrated circuits that use a variety of technologies and support different types of serial and wireless technologies as envisioned by the skilled person. The processor functionality of the present embodiments may be disposed in communication with one or more memory devices, such as a RAM or a ROM, via a storage interface. The storage interface may connect to memory devices including, without limitation, memory drives, removable disc drives, etc., employing connection protocols such as serial advanced technology attachment, integrated drive electronics, IEEE-1394, universal serial bus, fiber channel, small computer systems interface, etc. The memory drives may further include a drum, magnetic disc drive, magneto-optical drive, optical drive, redundant array of independent discs, solid-state memory devices, solid-state drives, etc. The memory devices may store a collection of program or database components, including, without limitation, an operating system, a user interface application, a user/application data (e.g., any data variables or data records discussed in this disclosure), etc.

It will be appreciated that, for clarity purposes, the above description has described embodiments of the technology described herein with reference to different functional units and processors. However, it will be apparent that any suitable distribution of functionality between different functional units may be used without detracting from the technology described herein. Hence, references to specific functional units are only to be seen as references to suitable means for providing the described functionality, rather than indicative of a strict logical or physical structure or organization.

The specification has described systems and methods for improving use of cooktops arising from attention to safety and foodstuff preparation by way of display and communication of real time cooking information. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments.

It is intended that the disclosure and examples be considered as exemplary only, with a true scope of disclosed embodiments being indicated by the following claims.

1. A cooking assisting unit for a cooktop having a cooktop surface including at least one heating element for heating foodstuff accommodated in a utensil, the cooking assisting unit comprising:
a remote temperature sensor positioned above the cooktop and configured to detect a remote temperature and generate an output corresponding to the remote temperature;
a digital light processor positioned above the cooktop and configured to display an image on at least one of the cooktop surface and foodstuff;
a processor arranged in communication with the temperature sensor and digital light processor, the processor configured to: receive the output corresponding to the remote temperature, determine real time cooking information, generate the image based on the real time cooking information, and cause the digital light processor to display the image; and
wherein the real time cooking information comprises foodstuff temperature, a cooking time and a meal recipe step; and
wherein the image is displayed on at least one of the foodstuff, cooktop surface and nearby surface.

2. The cooking assisting unit according to claim 1, further comprising:
a time of flight sensor positioned above the cooktop and in communication with the processor, the time of flight sensor configured to detect a presence and/or level of liquid in a utensil and generate an output corresponding to the presence and/or level of liquid; and
wherein the real time cooking information further comprises at least one of a cooktop surface temperature and a liquid level indicia.

3. The cooking assisting unit according to claim 2, further comprising:
a wireless and/or wired communication module arranged in communication with the processor and the cooktop, and
wherein the processor is further configured to: download recipes comprising step by step guides to meal preparation, determine a current step, next step and elapsed duration of the current step, and
wherein the cooking time comprises at least one of remaining cooking time in the current step and overall cooking time; and
wherein the meal recipe step comprises at least one of the current step and the next step.

4. The cooking assisting unit according to claim 3, wherein:
the cooktop is a smart cooktop; and
the processor is further configured to: receive temperature instruction from the smart cooktop, determine a difference between the temperature instruction and a current foodstuff temperature, and cause the cooktop to adjust heat generated by at least one heating element to reduce the difference.

5. The cooking assisting unit according to claim 4, wherein the time of flight sensor is further configured to detect a boil over condition and the alarm generator is further configured to generate an alarm in response the detected boil over condition.

6. The cooking assisting unit according to claim 1, wherein the digital light processor is laser based and at least one of the temperature sensor and time of flight sensor is infrared based and/or a sensor array.

7. The cooking assisting unit according to claim 1, wherein the temperature sensor is at least one of contactless and infrared.

8. The cooking assisting unit according to claim 1, further comprising affixing elements for affixing the cooking assisting unit above the cooktop, the affixing elements configured to mount the cooking assisting unit at least one of a vent hood, a swing arm and a microwave oven.

9. The cooking assisting unit according to claim 1, wherein the real time cooking information comprises a foodstuff image depicting an ideal version of foodstuff of a menu step.

10. A method for supporting foodstuff preparation in a utensil on a cooktop surface heating element, the method comprising the steps of:
determining a temperature of the foodstuff;
determining real time cooking information;
displaying the real time cooking information on at least one of the foodstuff, the utensil and the surface; and
wherein the real time cooking information comprises foodstuff temperature.

11. The method according to claim 10, further comprising the steps of:
determining with the time of flight sensor a likelihood of occurrence of a boil over in the utensil within a time threshold; and
generating an alarm if the likelihood is below the time threshold.

12. The method according to claim 11, wherein the alarm comprises at least one of: electronically communicated text messages; electronically communicated heat deactivation instructions to the heating element; audible tones; and visual displays of alphanumeric characters, images and/or colors.

13. The method according to claim 12, wherein the real time cooking information comprises at least one of duration of execution of a current recipe step, time to a next recipe step, action included in the next recipe step, the alarm and the temperature of foodstuff.
